(19) United States
(12) Patent Application Publication
(10) Pub. No.: US 2024/0343070 A1
(43) Pub. Date: Oct. 17, 2024

(54) PNEUMATIC TIRE

(71) Applicant: Toyo Tire Corporation, Itami-shi (JP)

(72) Inventor: Tsuyoshi Fujioka, Itami-shi (JP)

(73) Assignee: Toyo Tire Corporation, Itami-shi (JP)

(21) Appl. No.: 18/529,569

(22) Filed: Dec. 5, 2023

(30) Foreign Application Priority Data
Apr. 13, 2023 (JP) 2023-065824

(51) Int. Cl. B60C 11/03; B60C 11/12

(52) U.S. Cl. CPC B60C 11/0306; B60C 11/1236; B60C 2011/0353

(57) ABSTRACT

A first block including a pair of block circumferential groove surfaces including a first notch, and a pair of block axial groove surfaces. Each of the pair of block axial groove surfaces includes a first straight block end, a second straight block end, and a third straight block end. The first block includes a first thin groove connecting the first notches of the pair of block circumferential groove surfaces. The first thin groove including a first straight portion, a second straight portion, and a third straight portion. The first straight portion is disposed on a first bisector that bisects an area between the first straight block ends. The second straight portion is disposed on a second bisector that bisects an area between the second straight block ends. The third straight portion is disposed on a third bisector that bisects an area between the third straight block ends.

### CROSS REFERENCE TO RELATED APPLICATIONS

The present application claims priority based on Japanese Patent Application No. 2023-065824 filed on Apr. 13, 2023, the contents of which are incorporated herein by reference in its entirety.

### BACKGROUND OF THE INVENTION

The present disclosure relates to a pneumatic tire.

As a type of pneumatic tire, there is a pneumatic tire having a block row formed on a tread by a main groove extending in a tire circumferential direction and an axial groove intersecting the main groove as disclosed in JP2018-1933A.

### SUMMARY OF THE INVENTION

The present disclosure provides a pneumatic tire capable of achieving both high traction performance and high heel-and-toe wear resistance.

According of the present disclosure, there is provided a pneumatic tire having a plurality of main grooves extending in a tire circumferential direction; and a first block row interposed between two main grooves of the plurality of main grooves, wherein the first block row includes a first block, the first block including a pair of block circumferential groove surfaces each facing a corresponding one of the two main grooves and including a first notch at a central portion in a tire circumferential direction, and a pair of block axial groove surfaces connecting ends of the pair of block circumferential groove surfaces in the tire circumferential direction, each of the pair of block axial groove surfaces includes a first straight block end, a second straight block end inclined relative to the first straight block end, and a third straight block end inclined relative to the second straight block end, the first straight block end, the second straight block end, and third straight block end are arranged in order from a first side toward a second side in a tire axial direction, the first block includes a first thin groove connecting the first notches of the pair of block circumferential groove surfaces, the first thin groove having a groove width of greater than or equal to 2.0 mm and less than or equal to 5.0 mm, the first thin groove including a first straight portion, a second straight portion inclined relative to the first straight portion, and a third straight portion inclined relative to the second straight portion, the first straight portion, the second straight portion, and the third straight portion are arranged in order from the first side toward the second side in the tire axial direction, the first straight portion of the first thin groove is disposed on a first bisector that bisects an area between the first straight block ends, the second straight portion of the first thin groove is disposed on a second bisector that bisects an area between the second straight block ends, and the third straight portion of the first thin groove is disposed on a third bisector that bisects an area between the third straight block ends.

### BRIEF DESCRIPTION OF THE DRAWINGS

FIG. 1 is a developed view of a tread surface of a pneumatic tire of a first embodiment when the tire is new;

FIG. 2 is a partially enlarged view of a first block illustrated in FIG. 1;

FIG. 3 is a partially enlarged view of a second block illustrated in FIG. 1;

FIG. 4 is an explanatory diagram regarding bisectors in the first block and the second block illustrated in FIG. 1;

FIG. 5 is a plan view illustrating thin grooves in the first block and the second block;

FIG. 6 is a perspective view illustrating the thin grooves in the first block and the second block;

FIG. 7 is a cross-sectional view of a portion A-A along a second sipe in FIG. 5; and

FIG. 8 is a cross-sectional view of a portion B-B along a first sipe in FIG. 5.

### DETAILED DESCRIPTION OF THE PREFERRED EMBODIMENTS

### First Embodiment

A first embodiment of the present disclosure will be described hereinafter with reference to the drawings.

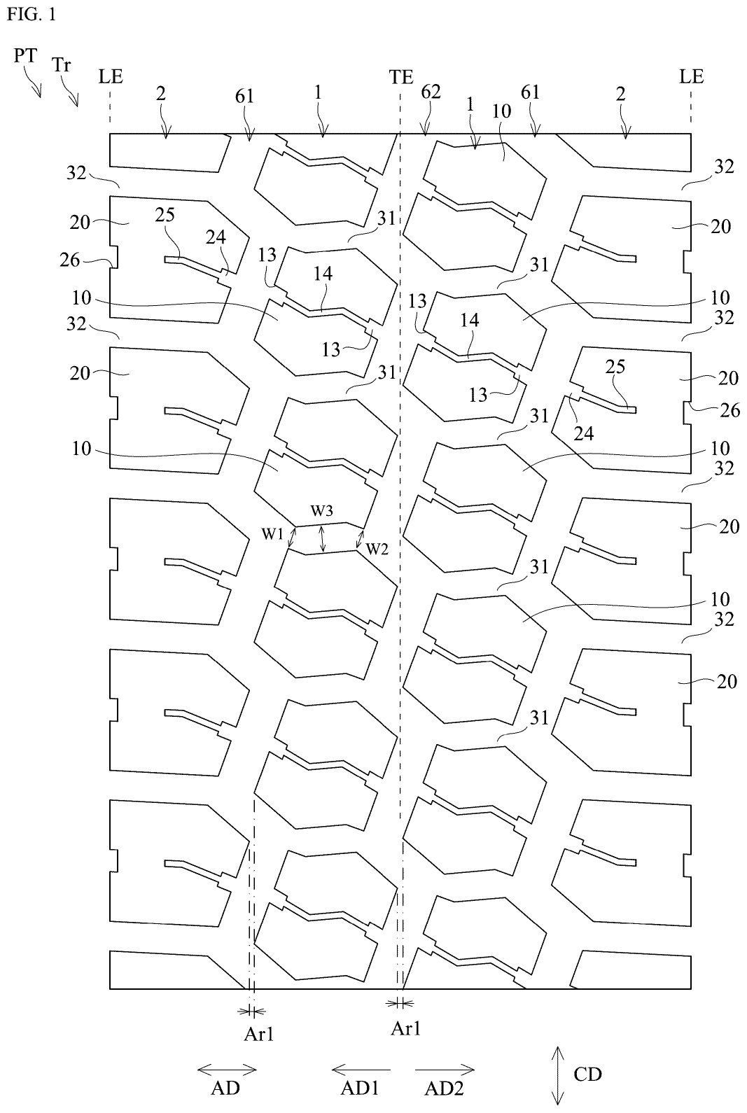

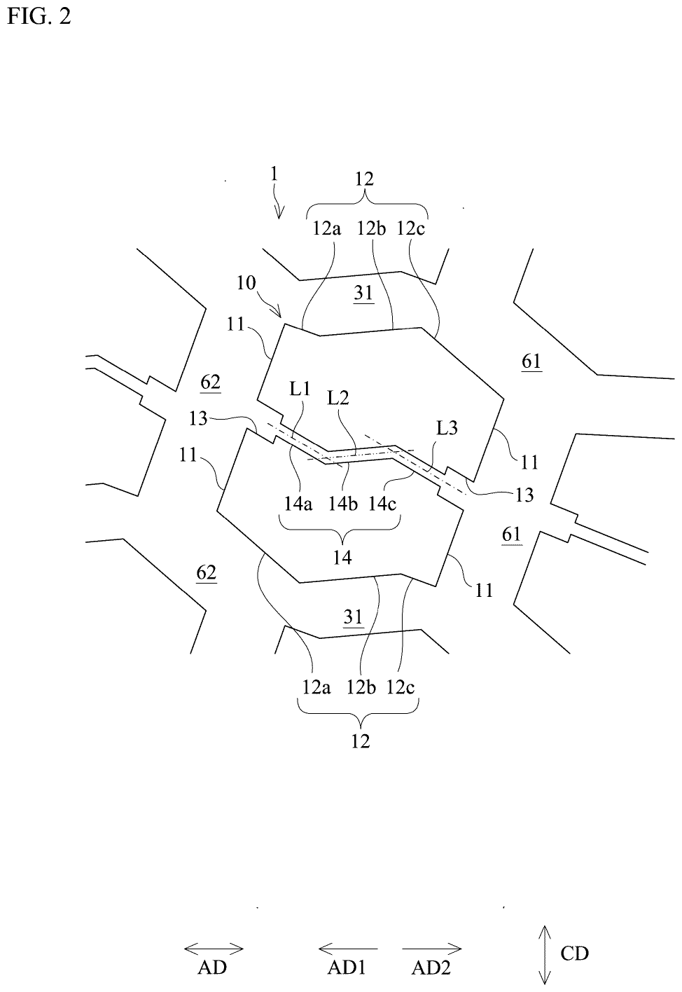

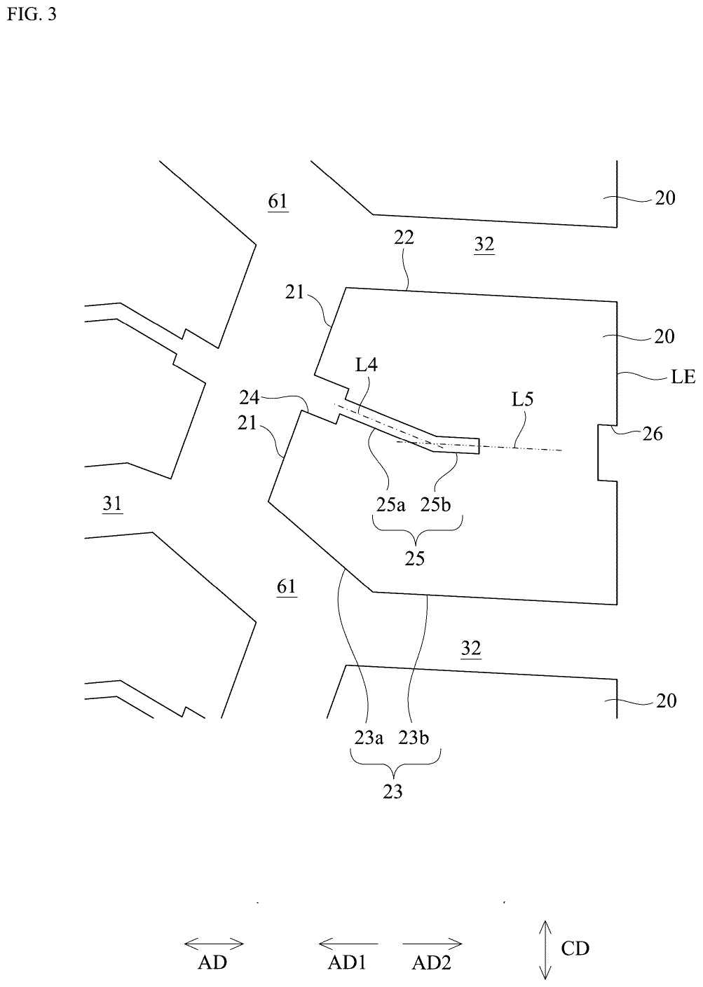

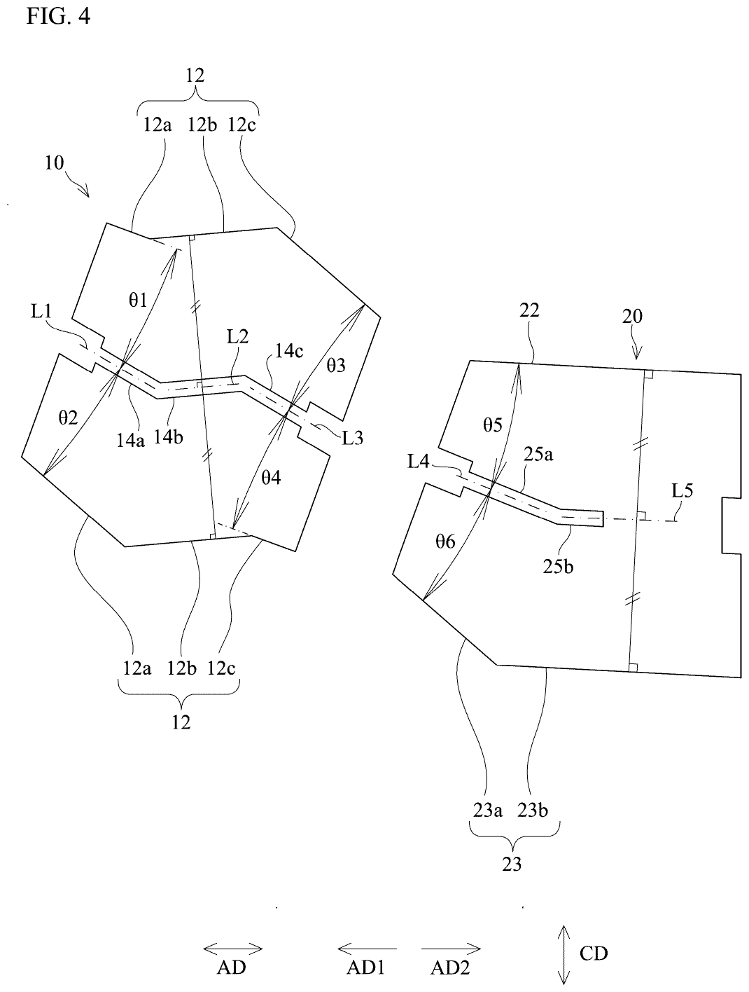

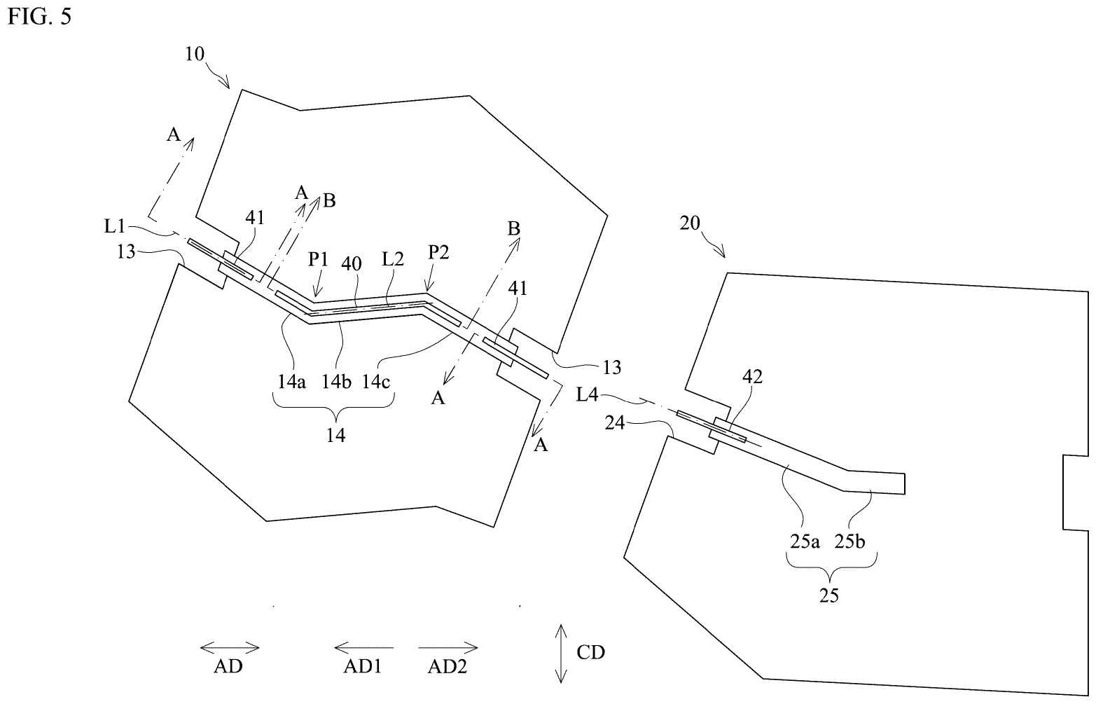

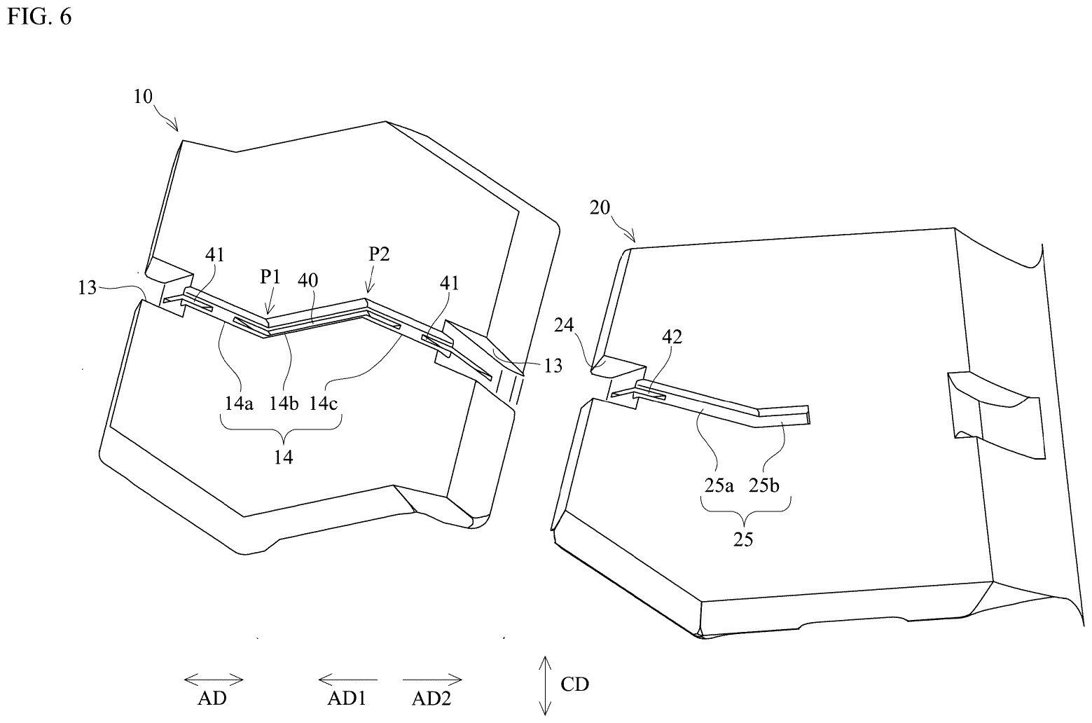

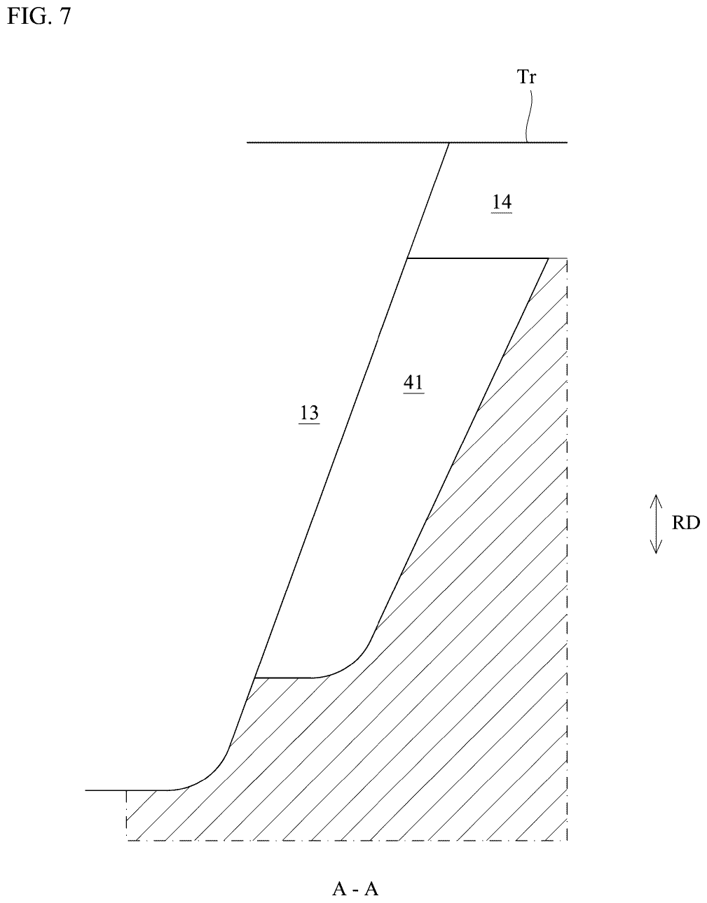

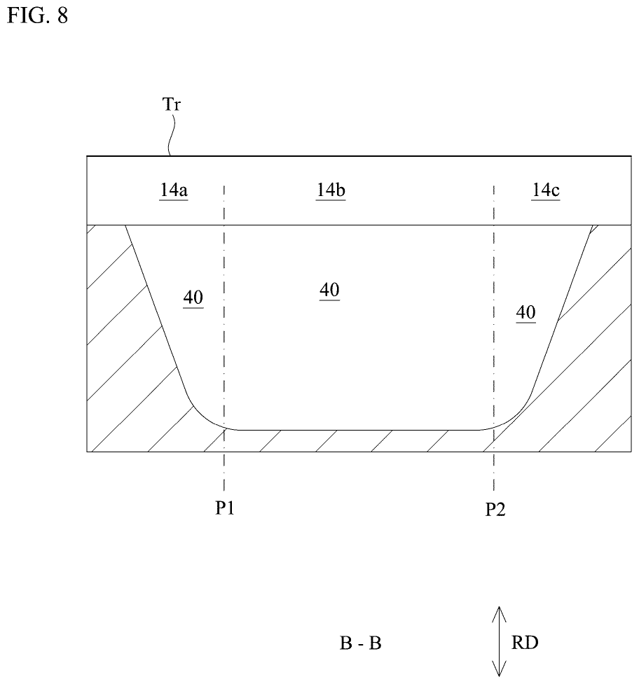

FIG. 1 is a developed view of a tread surface Tr of a pneumatic tire PT of a first embodiment when the tire is new. FIG. 2 is a partially enlarged view of a first block 10 illustrated in FIG. 1. FIG. 3 is a partially enlarged view of a second block 20 illustrated in FIG. 1. FIG. 4 is an explanatory diagram regarding bisectors in the first block 10 and the second block 20 illustrated in FIG. 1. FIG. 5 is a plan view illustrating thin grooves in the first block 10 and the second block 20. FIG. 6 is a perspective view illustrating the thin grooves in the first block 10 and the second block 20. FIG. 7 is a cross-sectional view of a portion A-A along a second sipe 41 in FIG. 5. FIG. 8 is a cross-sectional view of a portion B-B along a first sipe 40 in FIG. 5. FIGS. 1 to 8 show the tread shape of a new tire.

As illustrated in FIG. 1, a plurality of main grooves (61, 62, 61) continuously extending in a tire circumferential direction CD are provided on the tread surface Tr (ground contact surface that comes into contact with a road surface) of the pneumatic tire PT. In the first embodiment, the number of main grooves is three, but the number of main grooves can be changed. The three main grooves (61, 62, 61) are grooves each extending while bending in a zigzag shape in the tire circumferential direction CD. In the first embodiment, a shoulder main groove 61 located on an outermost side in a tire axial direction AD and a center main groove 62 closest to a tire equatorial plane TE are included.

As illustrated in FIG. 1, the shoulder main groove 61 and the center main groove 62 each have a see-through area Ar1. The see-through area Ar1 is an area that can be seen without being blocked by a groove wall forming the main grooves (61, 62) when the main grooves (61, 62) are viewed in the tire circumferential direction CD. It is possible to make, by providing the see-through area Ar1, traction performance and soil/water drainage performance high enough. It is preferable that a length of the see-through area Ar1 along the tire axial direction AD be greater than or equal to 10% and less than or equal to 30% of a width of the main grooves.

While there is no particular limitation with respect thereto, a constitution may be adopted in which, for example, the main grooves have groove widths not less than 3% of the distance (dimension in the tire axial direction AD) between ground contact ends LE, LE. Furthermore, while there is no particular limitation with respect thereto, a constitution may be adopted in which, for example, the main grooves have groove widths not less than 7.0 mm. Furthermore, while there is no particular limitation with respect thereto, a constitution may be adopted in which, for example, the main grooves have groove depths which—continuously in the tire circumferential direction CD—are deepest within the tread surface Tr. A constitution may be adopted in which TWIs (tread wear indicators) which indicate the usable limit due to wear are disposed at portions within the grooves of the main grooves.

Dimensions of each portion of the pneumatic tire, a tire maximum width position, and the like are values measured in a non-load state where the pneumatic tire is mounted on a normal rim and filled with a normal internal pressure.

Ground contact end LE is the outwardmost end in the tire axial direction AD of tread surface Tr (ground contact surface). Tread surface Tr (ground contact surface) refers to the tire surface that contacts the road surface when a tire inflated to normal internal pressure mounted on a normal rim and bearing a normal load is disposed in perpendicular fashion above a flat road surface.

A normal rim is that particular rim which is specified for use with a particular tire in the context of the body of standards that contains the standard that applies to the tire in question. This is referred to as a “standard rim” in the case of JATMA, and as a “measuring rim” in the case of TRA or ETRTO.

Normal internal pressure is that air pressure which is specified for use with a particular tire in the context of the body of standards that contains the standard that applies to the tire in question. This is referred to as “maximum air pressure” in the case of JATMA, the maximum value listed in the table entitled “Tire Load Limits at Various Cold Inflation Pressures” in the case of TRA, and as “inflation pressure” in the case of ETRTO.

Normal load is that load which is specified for use with a particular tire in the context of the body of standards that contains the standard that applies to the tire in question. This is referred to as “maximum load capacity” in the case of JATMA, the maximum value listed in the aforementioned table in the case of TRA, and as “load capacity” in the case of ETRTO.

Herein, an axial groove means a groove wider than a thin groove to be described later. The axial groove includes a first axial groove 31 and a second axial groove 32 to be described later. A notch is a groove having a length in the tire axial direction AD shorter than a width in the tire circumferential direction CD. The notch of the first embodiment is shallower than the main grooves, but may be equal in depth to the main grooves. The thin groove has a groove width of greater than or equal to 2.0 mm and less than or equal to 5.0 mm. The thin groove includes a first thin groove 14 and a second thin groove 25 to be described later. Herein, a sipe has a groove width of greater than or equal to 0.3 mm and less than or equal to 1.5 mm. The sipe includes the first sipe 40, the second sipe 41, and a third sipe 42.

### <First Block Row 1, Center Block Row>

The pneumatic tire PT includes a first block row 1 extending in the tire circumferential direction CD. The first block row 1 is interposed between two main grooves (61, 62) of the plurality of main grooves. The first block row 1 includes a plurality of the first blocks 10 arranged in the tire circumferential direction CD, and each of the first blocks 10 is defined by the two main grooves (61, 62) and the first axial groove 31. The first axial groove 31 connects the two main grooves (61, 62). In the first embodiment, two first block rows 1 are provided. The first block row 1 is disposed inside in the tire axial direction AD relative to the shoulder main groove 61 located on the outermost side in the tire axial direction AD, and can also be referred to as a so-called center block row.

As viewed from above as illustrated in FIG. 1, a groove width (W1, W2) of both ends of the first axial groove 31 in the tire axial direction AD is narrower than a groove width (W3) of a central portion of the first axial groove 31 in the tire axial direction AD. A groove depth of the central portion of the first axial groove 31 in the tire axial direction AD is shallower than a groove depth of both the ends of the first axial groove 31 in the tire axial direction AD. This makes it possible to suppress deformation of the first block 10 when a driving force acts.

It is preferable that a ratio of the groove depth of the first axial groove 31 to a groove depth of the main grooves (61, 62) be greater than or equal to 40% and less than or equal to 90%. If the ratio is less than 40%, traction tends to be insufficient over a period from when the tire is new to an early stage of wear and a mid-stage of wear, and if the ratio is greater than 90%, block rigidity may decrease to cause a deterioration in heel-and-toe wear resistance.

As illustrated in FIG. 2, the first block 10 includes a pair of block circumferential groove surfaces 11 facing the main grooves (61, 62) and a pair of block axial groove surfaces 12 connecting ends of the pair of block circumferential groove surfaces 11 in the tire circumferential direction CD. Each of the pair of block circumferential groove surfaces 11 includes a first notch 13 at a central portion in the tire circumferential direction CD. A ridgeline of each block circumferential groove surface 11 is, but not limited to, a straight line. Each of the pair of block axial groove surfaces 12 includes a first straight block end 12a, a second straight block end 12b, and a third straight block end 12c, each extending from a first side AD1 toward a second side AD2 in the tire axial direction AD. The second straight block end 12b is inclined relative to the first straight block end 12a. The third straight block end 12c is inclined relative to the second straight block end 12b. Respective ridgelines of the first straight block end 12a, the second straight block end 12b, and the third straight block end 12c are straight lines.

As described above, the ridgelines of the first straight block end 12a, the second straight block end 12b, and the third straight block end 12c intersect each other, so that the first block 10 has a shape that exhibits high traction performance.

The first block 10 includes the first thin groove 14 that connects the first notches 13 formed in the pair of block circumferential groove surfaces 11. A depth of the first thin groove 14 is shallower than the depth of the main grooves (61, 62). It is preferable that a ratio of the depth of the first thin groove 14 to the depth of the main groove (61, 62) be greater than or equal to 10% and less than or equal to 40%. If the ratio is less than 10%, it is difficult to obtain an effect of increasing traction performance by means of the first thin groove 14, and if the ratio is greater than 40%, the block rigidity of the first block 10 may decrease to cause a deterioration in heel-and-toe wear resistance.

The first thin groove 14 includes a first straight portion 14a, a second straight portion 14b, and a third straight portion 14c, each extending from the first side AD1 toward the second side AD2 in the tire axial direction AD. The second straight portion 14b is inclined relative to the first straight portion 14a. The third straight portion 14c is inclined relative to the second straight portion 14b. The first thin groove 14 is a groove bent at two places.

As described above, it is possible to increase traction performance by means of the first notch 13 and the first thin groove 14.

As illustrated in FIGS. 2 and 4, the first straight portion 14a of the first thin groove 14 is disposed on a first bisector L1 that bisects an area between the first straight block ends 12a. The first straight block ends 12a are not parallel to each other. The first bisector L1 is a line that bisects an angle of a corner where respective imaginary extension lines of the first straight block ends 12a intersect each other, and is a line equidistant from the pair of first straight block ends 12a. That is, an angle θ1 of a corner where one first straight block end 12a of the pair of first straight block ends 12a intersects the first bisector L1 is equal to an angle θ2 of a corner where the other first straight block end 12a of the pair of first straight block ends 12a intersects the first bisector L1.

The second straight portion 14b of the first thin groove 14 is disposed on a second bisector L2 that bisects an area between the second straight block ends 12b. The second straight block ends 12b are parallel to each other. The second bisector L2 is a line that is parallel to the second straight block ends 12b and is equidistant from the pair of second straight block ends 12b. That is, the pair of second straight block ends 12b and the second bisector L2 are parallel to each other.

The third straight portion 14c of the first thin groove 14 is disposed on a third bisector L3 that bisects an area between the third straight block ends 12c. The third straight block ends 12c are not parallel to each other. The third bisector L3 is a line that bisects an angle of a corner where respective imaginary extension lines of the third straight block ends 12c intersect each other, and is a line equidistant from the pair of third straight block ends 12c. That is, an angle θ3 of a corner where one third straight block end 12c of the pair of third straight block ends 12c intersects the third bisector L3 is equal to an angle θ4 of a corner where the other third straight block end 12c of the pair of third straight block ends 12c intersects the third bisector L3.

With this configuration, the first thin groove 14 that is bent bisects the first block 10 in the tire circumferential direction CD along the shapes of the block ends (12a, 12b, 12c) of the first block 10, which makes a balance in block rigidity uniform and allows an increase in heel-and-toe wear resistance.

Note that, in the first embodiment, the first bisector L1 and the third bisector L3 are parallel to each other. When the first bisector L1 and the third bisector L3 are parallel to each other, a block between the pair of first straight block ends 12a and a block between the pair of third straight block ends 12c become the same in shape, which makes the block prone to wear uniformly in the block plane and allows an increase in heel-and-toe wear resistance.

### <Second Block Row 2, Shoulder Block Row>

As illustrated in FIG. 1, the pneumatic tire PT includes a second block row 2 extending in the tire circumferential direction CD. The second block row 2 is disposed outside in the tire axial direction AD relative to the main groove (shoulder main groove 61) located on the outermost side in the tire axial direction AD among the plurality of main grooves. The second block row 2 includes a plurality of the second blocks 20 arranged in the tire circumferential direction CD, and each of the second blocks 20 is defined by the shoulder main groove 61 and the second axial groove 32. The second axial groove 32 connects the shoulder main groove 61 and the ground contact end LE. The second block row 2 is disposed outside in the tire axial direction AD relative to the shoulder main groove 61 located on the outermost side in the tire axial direction AD, and can also be referred to as a so-called shoulder block row.

It is preferable that a ratio of a groove depth of the second axial groove 32 to the groove depth of the main groove (61) be greater than or equal to 40% and less than or equal to 90%. If the ratio is less than 40%, traction tends to be insufficient over a period from when the tire is new to the early stage of wear and the mid-stage of wear, and if the ratio is greater than 90%, the block rigidity may decrease to cause a deterioration in heel-and-toe wear resistance. It is preferable that a maximum depth of the second axial groove 32 be shallower than a maximum depth of the first axial groove 31, but the maximum depth of the second axial groove 32 and the maximum depth of the first axial groove 31 may be the same.

As illustrated in FIG. 3, the second block 20 includes a second block circumferential groove surface 21 facing the main groove (shoulder main groove 61) and a pair of second block axial groove surfaces (22, 23) each extending from a corresponding one of ends of the second block circumferential groove surface 21 toward the ground contact end LE in the tire circumferential direction CD. A ridgeline of the second block circumferential groove surface 21 is a straight line, and a ridgeline of the ground contact end LE is a straight line, but each ridgeline is not limited to a straight line. At least one (23) of the pair of second block axial groove surfaces (22, 23) includes a fourth straight block end 23a and a fifth straight block end 23b, each extending toward the outside in the tire axial direction AD. The fifth straight block end 23b is inclined relative to the fourth straight block end 23a. The second block circumferential groove surface 21 includes a second notch 24 at a central portion in the tire circumferential direction CD.

As described above, ridgelines of the fourth straight block end 23a and the fifth straight block end 23b intersect each other, so that the second block 20 has a shape that exhibits high traction performance.

The second block 20 includes the second thin groove 25 extending from the second notch 24 toward the ground contact end LE and terminating in the second block 20. A depth of the second thin groove 25 is shallower than the depth of the main groove (61). It is preferable that a ratio of the depth of the second thin groove 25 to the depth of the main groove (61) be greater than or equal to 10% and less than or equal to 40%. If the ratio is less than 10%, it is difficult to obtain the effect of increasing traction performance by means of the second thin groove 25, and if the ratio is greater than 40%, block rigidity of the second block 20 may decrease to cause a deterioration in heel-and-toe wear resistance.

The second thin groove 25 includes a fourth straight portion 25a and a fifth straight portion 25b inclined relative to the fourth straight portion 25a, each extending toward the outside in the tire axial direction AD.

As described above, it is possible to increase traction performance by means of the second notch 24 and the second thin groove 25.

The second block 20 is susceptible to a force in the lateral direction (tire axial direction AD) and is prone to shoulder wear (shoulder drop wear). An outer end of the second thin groove 25 in the tire axial direction AD terminates in the second block 20. This makes it possible to increase, as compared with a case where the outer end of the second thin groove 25 in the tire axial direction AD opens to the ground contact end LE, the rigidity of the second block 20 and suppress shoulder wear (shoulder drop wear).

It is preferable that a ratio of a length of the second thin groove 25 in the tire axial direction AD to a length of the second block 20 in the tire axial direction AD be greater than or equal to 20% and less than or equal to 60%. If the ratio is less than 20%, it is difficult to obtain the effect of increasing traction performance by means of the second thin groove 25, and if the ratio is greater than 60%, the block rigidity of the second block 20 may decrease to cause a deterioration in heel-and-toe wear resistance.

As illustrated in FIGS. 3 and 4, the fourth straight portion 25a of the second thin groove 25 is disposed on a fourth bisector L4 that bisects an area between the fourth straight block end 23a and the second block axial groove surface 22 corresponding to the fourth straight block end 23a (block end located on the opposite side). The ridgeline of the fourth straight block end 23a and a ridgeline of the second block axial groove surface 22 are not parallel to each other. The fourth bisector L4 is a line that bisects an angle of a corner where respective imaginary extension lines of the ridgelines of the fourth straight block end 23a and the second block axial groove surface 22 intersect each other, and is a line equidistant from the ridgelines of the fourth straight block end 23a and the second block axial groove surface 22. That is, an angle θ5 of a corner where the second block axial groove surface 22 intersects the fourth bisector L4 is equal to an angle θ6 of a corner where the fourth straight block end 23a intersects the fourth bisector L4.

The fifth straight portion 25b of the second thin groove 25 is disposed on a fifth bisector L5 that bisects an area between the fifth straight block end 23b and the second block axial groove surface 22. The ridgelines of the fifth straight block end 23b and the second block axial groove surface 22 are parallel to each other. The fifth bisector L5 is a line that is parallel to the ridgelines of the fifth straight block end 23b and the second block axial groove surface 22 and is equidistant from the fifth straight block end 23b and the second block axial groove surface 22. That is, the fifth straight block end 23b, the second block axial groove surface 22, and the fifth bisector L5 are parallel to each other.

With this configuration, the second thin groove 25 that is bent bisects the second block 20 in the tire circumferential direction CD along the shapes of the block ends (22, 23a, 23b) of the second block 20, which makes a balance in block rigidity uniform and allows an increase in heel-and-toe wear resistance.

As illustrated in FIGS. 1 and 3, a fourth notch 26 is formed at a central portion of the ground contact end LE of the second block 20 in the tire circumferential direction CD. The fourth notch 26 thus formed can disperse, when a force in the lateral direction (tire axial direction AD) acts on the second block 20, the force to increase shoulder wear resistance (shoulder drop wear resistance). It is preferable that the fourth notch 26 be disposed on the extension of the second thin groove 25, that is, on the fifth bisector L5.

### <Sipe at Bottom of First Thin Groove 14>

As illustrated in FIGS. 5 and 6, the first thin groove 14 includes, at the bottom thereof, sipes (40, 41) narrower in groove width. This allows the sipes (40, 41) to provide traction even after the first thin groove 14 is worn away. Further, the sipes (40, 41) are disposed at a groove width center of the first thin groove 14. The sipes (40, 41) include the first sipe 40 and the second sipe 41. The first sipe 40 is disposed at a central portion of the first sipe 40 in the longitudinal direction, terminates in the first block 10, and does not open to the first notch 13. At least a part of the first sipe 40 is disposed on the second bisector L2. The first thin groove 14 includes a first bent portion P1 that connects the first straight portion 14a and the second straight portion 14b, and a second bent portion P2 that connects the second straight portion 14b and the third straight portion 14c. The first sipe 40 extends from the second straight portion 14b to the first straight portion 14a via the first bent portion P1, and extends from the second straight portion 14b to the third straight portion 14c via the second bent portion P2.

As described above, the first sipe 40 extends across the first bent portion P1 and the second bent portion P2, so that when a force acts in the lateral direction (tire axial direction AD) during cornering, wall surfaces of the blocks divided by the first sipe 40 come into contact with each other to suppress excessive deformation of the first block 10, which allows an increase in heel-and-toe wear resistance.

As illustrated in FIG. 8, the first sipe 40 has the deepest portion located in the second straight portion 14b. A portion of the first sipe 40 located outside the first bent portion P1 and the second bent portion P2 is gradually shallower from the first bent portion P1 and the second bent portion P2. The first bent portion P1 and the second bent portion P2 tends to suffer from distortion during driving or cornering, and a crack starting from the first bent portion P1 and the second bent portion P2 may be generated. It is therefore possible to cause, by making the first sipe 40 gradually shallower from the first bent portion P1 and the second bent portion P2 to angle the sipe wall, the first sipe 40 to become shorter due to wear and suppress deformation of the first block 10.

As illustrated in FIGS. 5 and 6, the second sipe 41 is disposed at each end and in the vicinity of each end of the first thin groove 14, and opens to the first notch 13. The second sipe 41 is disposed on each of the first bisector L1 and the third bisector L3. As illustrated in FIG. 7, the second sipe 41 is gradually deeper from the inside to the outside in the longitudinal direction of the first thin groove 14.

It is preferable that a ratio of the total depth of the first sipe 40 and the first thin groove 14 to the depth of the main grooves (61, 62) be greater than or equal to 50% and less than or equal to 80%. The same applies to a ratio of the total depth of the second sipe 41 and the first thin groove 14 to the depth of the main grooves (61, 62). If the ratio is less than 50%, traction performance at the mid-stage of wear (after the first thin groove 14 is worn away) becomes insufficient. If the ratio is greater than 80%, the block rigidity may decrease to cause a deterioration in heel-and-toe wear resistance.

### <Sipe at Bottom of Second Thin Groove 25>

As illustrated in FIGS. 5 and 6, the second thin groove 25 includes, at the bottom thereof, the third sipe 42 narrower in groove width. This allows the third sipe 42 to provide traction even after the second thin groove 25 is worn away. In the first embodiment, the third sipe 42 has a groove width of greater than or equal to 0.3 mm and less than or equal to 1.5 mm. Further, the third sipe 42 is disposed at a groove width center of the second thin groove 25. The third sipe 42 is disposed at an end and in the vicinity of the end of the second thin groove 25, and opens to the second notch 24. The third sipe 42 is disposed on the fourth bisector L4. Although a cross-sectional shape of the third sipe 42 is not illustrated, the third sipe 42 has the same shape as the second sipe 41 illustrated in FIG. 7.

It is preferable that a ratio of the total depth of the third sipe 42 and the second thin groove 25 to the depth of the main groove (61) be greater than or equal to 50% and less than or equal to 80%. If the ratio is less than 50%, traction performance at the mid-stage of wear (after the second thin groove 25 is worn away) becomes insufficient. If the ratio is greater than 80%, the block rigidity may decrease to cause a deterioration in heel-and-toe wear resistance.

### <Positional Relation Among First Thin Groove 14, Second Thin Groove 25, First Notch 13, and Second Notch 24>

As illustrated in FIG. 1, when the first thin groove 14, the second thin groove 25, the first notch 13, and the second notch 24 are projected onto a plane parallel to the tire circumferential direction CD, an area where the first thin groove 14 is projected, an area where the second thin groove 25 is projected, an area where the first notch 13 is projected, and an area where the second notch 24 is projected are sequentially continuous along the tire circumferential direction CD. As a result, the four elements are positioned, in a sequential manner, for a long time at the end of the ground contact surface in the tire circumferential direction CD as the tire rotates, so that it is possible to make a period during which traction is exerted during driving longer and increase traction performance.

Further, as illustrated in FIG. 1, when the first thin groove 14 of the first block 10 and the second thin groove 25 of the second block 20 are projected onto a plane parallel to the tire circumferential direction CD, the area where the first thin groove 14 is projected and the area where the second thin groove 25 is projected are separate from each other in the tire circumferential direction CD. This makes it possible to prevent the first thin groove 14 and the second thin groove 25 from being simultaneously positioned at the end of the ground contact surface in the tire circumferential direction CD as the tire rotates to suppress fluctuations of traction during tire rotation, and effectively exert traction.

With a sipe opening to the tread surface Tr and having a groove width of less than or equal to 1.5 mm provided, it is possible to increase traction performance. With a sipe opening to the tread surface Tr and having a groove width of less than or equal to 1.5 mm provided in a tire having a large diameter and having a relatively large load imposed thereon, a crack may be generated from the sipe to cause chipping (damage causing the tread surface Tr to partially come off). In particular, a tire for off-road driving is more prone to chipping. Therefore, in the first embodiment, a land including the first block 10 and the second block 20 includes no sipe that opens to the tread surface Tr and has a groove width of less than or equal to 1.5 mm. This makes it possible to suppress or prevent chipping.

### [Modification]

(A) In the first embodiment, the see-through area Ar1 is provided in the main grooves (61, 62), but the see-through area Ar1 need not be provided in the main grooves (61, 62).
(B) In the first embodiment, the first block row 1 has two rows, but may have one row or three or more rows.
(C) In the first embodiment, the ridgeline of the block circumferential groove surface 11 is one straight line, but may be a curved line or a combination of a straight line and a curved line. The ridgeline of the second block circumferential groove surface 21 is one straight line, but may be a curved line or a combination of a straight line and a curved line.
(D) In the first embodiment, the first bisector L1 and the third bisector L3 are parallel to each other, but the first bisector L1 and the third bisector L3 need not be parallel to each other and may extend in directions intersecting each other.
(E) In the first embodiment, all the blocks constituting the first block row 1 are the first blocks 10, but the first block row 1 is not limited to such a configuration. It is only required that the first block row 1 include at least one first block 10.

In the first embodiment, all the blocks constituting the second block row 2 are the second blocks 20, but the second block row 2 is not limited to such a configuration. It is only required that the second block row 2 include at least one second block 20.
(F) The second block 20 of the first embodiment has the second block axial groove surface 22 and the corresponding second block axial groove surface 23 as a combination of one straight line and two straight lines, but the second block 20 is not limited to such a configuration. For example, a combination of two straight lines and two straight lines may be used.
   [1]

As described above, as in the first embodiment, the pneumatic tire PT may have a plurality of main grooves (61, 62) extending in a tire circumferential direction CD; and a first block row 1 interposed between two main grooves (61, 62) of the plurality of main grooves; wherein the first block row 1 includes a first block 10, the first block 10 including a pair of block circumferential groove surfaces 11 each facing a corresponding one of the two main grooves (61, 62) and including a first notch 13 at a central portion in a tire circumferential direction CD, and a pair of block axial groove surfaces 12 connecting ends of the pair of block circumferential groove surfaces 11 in the tire circumferential direction CD; each of the pair of block axial groove surfaces 12 includes a first straight block end 12a, a second straight block end 12b inclined relative to the first straight block end 12a, and a third straight block end 12c inclined relative to the second straight block end 12b, the first straight block end 12a, the second straight block end 12b, and third straight block end 12c are arranged in order from a first side AD1 toward a second side AD2 in a tire axial direction AD; the first block 10 includes a first thin groove 14 connecting the first notches 13 of the pair of block circumferential groove surfaces 11, the first thin groove 14 having a groove width of greater than or equal to 2.0 mm and less than or equal to 5.0 mm, the first thin groove 14 including a first straight portion 14a, a second straight portion 14b inclined relative to the first straight portion 14a, and a third straight portion 14c inclined relative to the second straight portion 14b, the first straight portion 14a, the second straight portion 14b, and the third straight portion 14c are arranged in order from the first side AD1 toward the second side AD2 in the tire axial direction AD; the first straight portion 14a of the first thin groove 14 is disposed on a first bisector L1 that bisects an area between the first straight block ends 12a; the second straight portion 14b of the first thin groove 14 is disposed on a second bisector L2 that bisects an area between the second straight block ends 12b; and the third straight portion 14c of the first thin groove 14 is disposed on a third bisector L3 that bisects an area between the third straight block ends 12c.

As described above, the first notch 13 and the first to third straight block ends (12a, 12b, 12c) form a block shape that allows the first block 10 to exhibit high traction performance. It is possible to increase traction performance by means of the first thin groove 14 that is bent and has a groove width of greater than or equal to 2.0 mm, the first thin groove 14 connecting the first notches 13 and including the first to third straight portions (14a, 14b, 14c). Furthermore, the first to third straight portions (14a, 14b, 14c) are respectively disposed on the first to third bisectors (L1, L2, L3) that bisect areas between the first to third straight block ends (12a, 12b, 12c), respectively, so that the first thin groove 14 that is bent bisects the first block 10 in the tire circumferential direction CD along the shapes of the block ends to make a balance in block rigidity uniform, thereby allowing an increase in heel-and-toe wear resistance.

It is therefore possible to make traction and heel-and-toe wear resistance high enough.

[2]

In the pneumatic tire of the above [1], the pneumatic tire may have a second block row 2 disposed outside in the tire axial direction AD relative to a shoulder main groove 61 located on an outermost side in the tire axial direction AD among the plurality of main grooves; wherein the second block row 2 includes a second block 20, the second block 20 including a second block circumferential groove surface 21 facing the shoulder main groove 61 and including a second notch 24 at a central portion in the tire circumferential direction CD, and a pair of second block axial groove surfaces (22, 23) extending from both ends of the second block circumferential groove surface 21 in the tire circumferential direction CD toward a ground contact end LE; one (23) of the pair of second block axial groove surfaces includes a fourth straight block end 23a and a fifth straight block end 23b inclined relative to the fourth straight block end 23a, the fourth straight block end 23a and the fifth straight block end 23b are arranged in order from the first side AD1 toward the second side AD2 in the tire axial direction AD; the second block 20 includes a second thin groove 25 extending from the second notch 24 toward the ground contact end LE and terminating in the second block 20, the second thin groove 25 having a groove width of greater than or equal to 2.0 mm and less than or equal to 5.0 mm, the second thin groove 25 including a fourth straight portion 25a and a fifth straight portion 25b inclined relative to the fourth straight portion 25a, the fourth straight portion 25a and the fifth straight portion 25b are arranged in order from the first side AD1 toward the second side AD2 in the tire axial direction AD; the fourth straight portion 25a of the second thin groove 25 is disposed on a fourth bisector L4 that bisects an area between the fourth straight block end 25a and the second block axial groove surface 22; and the fifth straight portion 25b of the second thin groove 25 is disposed on a fifth bisector L5 that bisects an area between the fifth straight block end 25b and the second block axial groove surface 22.

As described above, the second notch 24 and the fourth to fifth straight block ends (23a, 23b) form a block shape that allows the second block 20 to exhibit high traction performance. It is possible to increase traction performance by means of the second thin groove 25 that is bent and has a groove width of greater than or equal to 2.0 mm, the second thin groove 25 extending from the second notch 24 toward the ground contact end LE and terminating in the second block 20, and including the fourth and fifth straight portions (25a, 25b). Furthermore, the fourth and fifth straight portions (25a, 25b) are respectively disposed on the fourth and fifth bisectors (L4, L5) that bisect areas between the fourth and fifth straight block ends (23a, 23b), respectively, so that the second thin groove 25 that is bent bisects the second block 20 in the tire circumferential direction CD along the shapes of the block ends to make a balance in block rigidity uniform, thereby allowing an increase heel-and-toe wear resistance.

[3]

In the pneumatic tire of the above [2], the first block row 1 may include a first axial groove 31 that opens to the two main grooves (61, 62) and defines the first block 10; the second block row 2 may include a second axial groove 32 that opens to the shoulder main groove 61 and the ground contact end LE and defines the second block 20; and the second axial groove 32 is shallower than the first axial groove 31.

The second blocks 20 of the second block row 2 constituting a shoulder land are more susceptible to a force in the lateral direction (tire axial direction AD) than the blocks of the other block rows, and thus are more prone to shoulder wear (shoulder drop wear). It is possible to increase, by making the second axial groove 32 shallower than the first axial groove 31, shoulder wear resistance (shoulder drop wear resistance).

[4]

In the pneumatic tire of any one of the above [1] to [3], a sipe (first sipe 40) may be formed at a bottom of the first thin groove 14, and a groove width of the sipe (first sipe 40) may be narrower than the groove width of the first thin groove 14.

With this configuration, it is possible to make traction high enough by means of the first sipe 40 even after the first thin groove 14 is worn away. Further, even before the first thin groove 14 is worn away, the first thin groove 14 becomes wide due to the presence of the first sipe 40 at the bottom of the first thin groove 14 as compared with a case where the first sipe 40 is not provided, so that it is possible to cause the first thin groove 14 that becomes wider to follow the road surface to be less susceptible to skid, and effectively increase traction performance.

[5]

In the pneumatic tire of the above [4], the sipe (first sipe 40) may be disposed on the second bisector L2.

With this configuration, the first block 10 is uniformly divided in the tire circumferential direction CD after the first thin groove 14 is worn away, so that it is possible to make a balance in block rigidity excellent and increase heel-and-toe wear resistance.

[6]

In the pneumatic tire of the above [5], the first thin groove 14 may include a first bent portion P1 that connects the first straight portion 14a and the second straight portion 14b, and a second bent portion P2 that connects the second straight portion 14b and the third straight portion 14c, and the sipe (first sipe 40) may extend from the second straight portion 14b to the first straight portion 14a via the first bent portion P1, and may extend from the second straight portion 14b to the third straight portion 14c via the second bent portion P2.

With this configuration, the sipe (first sipe 40) extends across the first bent portion P1 and the second bent portion P2, so that it is possible to suppress deformation of the block and increase heel-and-toe wear resistance.

[7]

In the pneumatic tire of any one of the above [1] to [6], the plurality of main grooves (61, 62) may include a see-through area Ar1.

With this configuration, it is possible to make traction performance and soil/water drainage performance high enough.

[8]

In the pneumatic tire of any one of the above [1] to [7], a tread surface Tr of the first block 10 may be devoid of sipes having a width of less than or equal to 1.5 mm.

When a tire having a large load imposed thereon and having a relatively large size has a width of a groove (sipe) opening to the tread surface of less than or equal to 1.5 mm, the tire may suffer from chipping, that is, the tread surface Tr may partially come off. Since a tread surface Tr of the first block 10 is devoid of sipes having a width of less than or equal to 1.5 mm, it is possible to suppress chipping.

While embodiments in accordance with the present disclosure have been described above with reference to the drawings, it should be understood that the specific constitution thereof is not limited to these embodiments. The scope of the present disclosure is as indicated by the claims and not merely as described at the foregoing embodiments, and moreover includes all variations within the scope of or equivalent in meaning to that which is recited in the claims.

Structure employed at any of the foregoing embodiment(s) may be employed as desired at any other embodiment(s). The specific constitution of the various components is not limited only to the foregoing embodiment(s) but admits of any number of variations without departing from the gist of the present disclosure.

1. A pneumatic tire comprising:
a plurality of main grooves extending in a tire circumferential direction; and
a first block row interposed between two main grooves of the plurality of main grooves, wherein
the first block row includes a first block, the first block including a pair of block circumferential groove surfaces each facing a corresponding one of the two main grooves and including a first notch at a central portion in a tire circumferential direction, and a pair of block axial groove surfaces connecting ends of the pair of block circumferential groove surfaces in the tire circumferential direction,
each of the pair of block axial groove surfaces includes a first straight block end, a second straight block end inclined relative to the first straight block end, and a third straight block end inclined relative to the second straight block end,
the first straight block end, the second straight block end, and third straight block end are arranged in order from a first side toward a second side in a tire axial direction,
the first block includes a first thin groove connecting the first notches of the pair of block circumferential groove surfaces, the first thin groove having a groove width of greater than or equal to 2.0 mm and less than or equal to 5.0 mm, the first thin groove including a first straight portion, a second straight portion inclined relative to the first straight portion, and a third straight portion inclined relative to the second straight portion,
the first straight portion, the second straight portion, and the third straight portion are arranged in order from the first side toward the second side in the tire axial direction,
the first straight portion of the first thin groove is disposed on a first bisector that bisects an area between the first straight block ends,
the second straight portion of the first thin groove is disposed on a second bisector that bisects an area between the second straight block ends, and
the third straight portion of the first thin groove is disposed on a third bisector that bisects an area between the third straight block ends.

2. The pneumatic tire according to claim 1, further comprising a second block row disposed outside in the tire axial direction relative to a shoulder main groove located on an outermost side in the tire axial direction among the plurality of main grooves, wherein
the second block row includes a second block, the second block including a second block circumferential groove surface facing the shoulder main groove and including a second notch at a central portion in the tire circumferential direction, and a pair of second block axial groove surfaces extending from both ends of the second block circumferential groove surface in the tire circumferential direction toward a ground contact end,
one of the pair of second block axial groove surfaces includes a fourth straight block end and a fifth straight block end inclined relative to the fourth straight block end,
the fourth straight block end and the fifth straight block end are arranged in order from the first side toward the second side in the tire axial direction,
the second block includes a second thin groove extending from the second notch toward the ground contact end and terminating in the second block, the second thin groove having a groove width of greater than or equal to 2.0 mm and less than or equal to 5.0 mm, the second thin groove including a fourth straight portion and a fifth straight portion inclined relative to the fourth straight portion,
the fourth straight portion and the fifth straight portion are arranged in order from the first side toward the second side in the tire axial direction,
the fourth straight portion of the second thin groove is disposed on a fourth bisector that bisects an area between the fourth straight block end and the second block axial groove surface, and
the fifth straight portion of the second thin groove is disposed on a fifth bisector that bisects an area between the fifth straight block end and the second block axial groove surface.

3. The pneumatic tire according to claim 2, wherein
the first block row includes a first axial groove that opens to the two main grooves and defines the first block,
the second block row includes a second axial groove that opens to the shoulder main groove and the ground contact end and defines the second block, and
the second axial groove is shallower than the first axial groove.

4. The pneumatic tire according to claim 1, wherein a sipe is formed at a bottom of the first thin groove, and a groove width of the sipe is narrower than the groove width of the first thin groove.

5. The pneumatic tire according to claim 4, wherein the sipe is disposed on the second bisector.

6. The pneumatic tire according to claim 5, wherein
the first thin groove includes a first bent portion that connects the first straight portion and the second straight portion, and a second bent portion that connects the second straight portion and the third straight portion, and the sipe extends from the second straight portion to the first straight portion via the first bent portion, and extends from the second straight portion to the third straight portion via the second bent portion.

7. The pneumatic tire according to claim 1, wherein the plurality of main grooves include a see-through area.

8. The pneumatic tire according to claim 1, wherein a tread surface of the first block is devoid of sipes having a width of less than or equal to 1.5 mm.
